(19) United States
(12) Patent Application Publication
(10) Pub. No.: US 2009/0005066 A1
(43) Pub. Date: Jan. 1, 2009

(54) METHOD AND APPARATUS FOR OBTAINING A ZIP CODE

(76) Inventors: Cynthia Florkey, Fort Collins, CO (US); Ruth Schaefer Gayde, Naperville, IL (US); Todd Cartwright Morgan, Oak Park, IL (US); John Richard Rosenberg, Elmhurst, IL (US)

Correspondence Address: FAY SHARPE/LUCENT, 1100 SUPERIOR AVE, SEVENTH FLOOR, CLEVELAND, OH, 44114, US

(21) Appl. No.: 11/771,352

(22) Filed: Jun. 29, 2007

(51) Int. Cl. B60Q 1/00

(52) U.S. Cl. 455/456.1

(57) ABSTRACT

An apparatus for obtaining a zip code of where a user is at the moment is provided. The apparatus comprises: a core network; an access server operatively connected to the core network providing network access for the communication device; and a zip code location database server operatively connected to the core network, wherein the zip code location database server is adapted to store zip code location information for one or more IDs in the core network.

### BACKGROUND OF THE INVENTION

This invention relates to a method and apparatus for obtaining a zip code of where a user is at the moment, in order to enable fast, cost effective, location-based services. While the invention is particularly directed to the art of telecommunications, and will be thus described with specific reference thereto, it will be appreciated that the invention may have usefulness in other fields and applications.

By way of background, there are location-based services that use longitude and latitude to help users determine their location or determine directions to a particular destination. These services usually require specialized software and hardware in the user's mobile/PC/handset and often require the user know the full address of his/her final destination.

Users today also find business locations using simple queries based on zip codes. For example, on the Borders website there is an option to “find the store nearest you” by simply entering a zip code. Alternatively, at www.google.com, the user can enter a Google search such as “sushi <zip code>” to find sushi restaurants near the <zip code>. These are simple search mechanisms, requiring no specialized location software and only requiring that the user knows their zip code.

While most users would know their zip code of their home or office, when traveling away from home/office this is not a commonly known piece of information. Yet, when traveling to a new city or a different part of a home city, a user is probably more likely to need the assistance of locating a business near to them.

Cellular Geographic Service Area (CGSA) describes the physical area over which a cellular carrier is licensed to provide service. CGSA identifiers are generally broadcast in the network. Location Area identifiers are also used in cellular networks. However, these identifiers are cellular network specific and are generally not useful to end users.

Location based services in cellular networks are typically based on longitude/latitude coordinates derived from mobile reception of satellite signals. To accomplish these services, a set of network elements are needed that are devoted to communicating satellite information to the mobiles, providing position calculations from raw measurements, implementing various alternative algorithms when satellites are not visible, and communicating determined position to querying network elements. There is cost associated with these network elements, a time delay to provide precise location, and a certain throughput capacity in terms of locations/hour supported by the network.

The present invention contemplates a new and improved method and apparatus that resolves the above-referenced difficulties and others.

### SUMMARY OF THE INVENTION

A method and apparatus for getting a zip code from the network are provided. For example, when traveling to a new city on a business trip to meet with customers, John may want to locate the Kinkos nearest his customer's office building to make extra copies of his presentation. Alternatively, after a successful presentation with the customer, he may want have a relaxing dinner at a sushi restaurant close to his hotel. If John was able to simply determine the zip code of his customer's office or his hotel, he could use the browser on his cell phone or PC to find the Kinkos or Sushi Restaurant most convenient to his location.

In one aspect of the invention, an apparatus for determining the zip code of a communication device in a wireless-based network is provided. The apparatus comprises: a core network; an access server operatively connected to the core network providing network access for one or more communication devices; and a zip code location database server operatively connected to the core network, wherein the zip code location database server is adapted to store zip code location information for one or more IDs in the core network.

In another aspect of the invention, a method of obtaining the zip code corresponding to the location of a user's communication device in a wireless-based network is provided. The method comprises: storing zip code data for a plurality of wireless access points, cell sites, cell site antennas and cell sectors in a server; registering a communication device with the network; receiving a zip code query from the communication device; obtaining the zip code in which the communication device is located; and forwarding the zip code to the communication device.

In yet another aspect of the invention, a method of obtaining the zip code corresponding to the location of a user's a communication device in an IP-based network is provided. The method comprises: storing zip code data for a plurality of access ports in a zip code location database server; obtaining the zip code relating to the location of the communication device; and forwarding the zip code to the communication device.

In yet another aspect of the invention, a method of obtaining the zip code corresponding to the location of a communication device in the public switched telephone network (PSTN) is provided. The method comprises: storing zip code data for a plurality of wireline subscribers in a zip code location database server; receiving a zip code query from a wireline user having a communication device with an associated directory number; querying the zip code database server with the associated directory number; and forwarding the zip code in which the communication device is located to the user.

In yet another aspect of the present invention, a method of providing the zip code for the location of a communication device, where the communication device calls a public phone number to access the zip code. The method comprises: dynamically populating a zip code location database server to provide a mapping of ID to zip code; receiving a zip code query from a user having a communication device with an associated ID; querying the zip code database server with the associated ID; and providing the zip code in which the communication device is located to the user.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 depicts a basic communication system suitable for implementing aspects of the present invention;

FIG. 2 depicts a wireless-based communication system suitable for implementing aspects of the present invention;

FIG. 3 depicts an IMS/IP-based communication system suitable for implementing aspects of the present invention;

FIG. 4 depicts a PSTN-based communication system suitable for implementing aspects of the present invention;

FIG. 5 is a flowchart of a method of providing a zip code in a wireless network according to aspects of the present invention;

FIG. 6 is a flowchart of a method of providing a zip code in an IMS/IP network according to aspects of the present invention; and

FIG. 7 is a flowchart of a method of providing a zip code in the PSTN according to aspects of the present invention.

### DETAILED DESCRIPTION

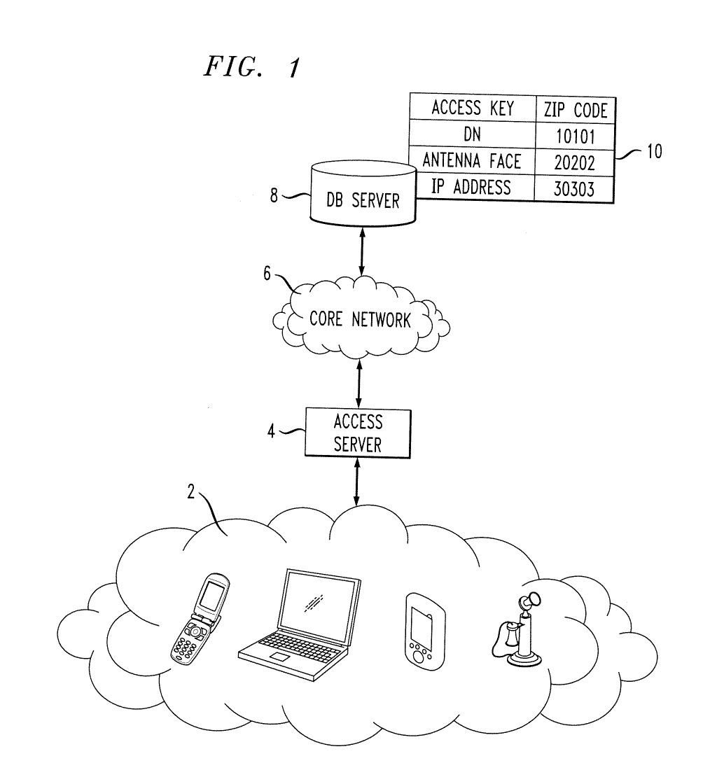

Referring now to the drawings wherein the showings are for purposes of illustrating the exemplary embodiments only and not for purposes of limiting the claimed subject matter, FIG. 1 provides a view of a basic system into which the presently described embodiments may be incorporated. As shown generally, FIG. 1 includes a communication device 2, an access server 4, a core network 6, and a zip code location database server 8.

These network entities or elements represent functional blocks or units that perform various logical functions that are implementation-independent. In other words, one or more of the above-mentioned network entities may be constructed in different physical configurations by different mobile service providers and, therefore, the model shown in FIG. 1 does not imply either a specific physical implementation of a network entity shown therein or a specific interconnection between two or more network entities shown therein.

It is therefore emphasized that the arrangement shown in FIG. 1 is for illustration only. The network entities shown in FIG. 1 may not represent actual physical connection, especially when call-routing involves many more cells and, thus, many more network entities, in a wireless network. In short, the network topology in FIG. 1 is a symbolic or logical representation of various functional blocks comprising a wireless network and does not imply a fixed, physical implementation of those functional blocks. A service provider may choose not to provide all the network entities or all the interconnections illustrated in FIG. 1 in a given geographic area or cell. Further, more than one functional unit may be implemented on a single physical device, or, alternatively, some functional blocks may represent separate physical devices.

The communication device 2 may comprise, for example, a mobile station, a laptop or personal computer (PC), a personal digital assistant (PDA), a wireline phone, a softphone, a handheld PC, a payphone, a PBX office/hotel phone, etc. Of course, this list is not exhaustive and other types of communication devices may be used with the invention.

The access server 4 is operatively connected to a core network 6, thus providing access for the communication device 2, depending, of course, upon the type of communication device being used.

The core network 6 may comprise, for example, an IMS (IP Multimedia Subsystem) network, an IP network, a wireless network (CDMA, TDMA, AMPS, IDEN, WIFI, WIMAX or other type OFDMA-type networks UMTS, GSM, etc.), or the PSTN (public switched telephone network), again depending upon the type of communication device being used.

The database server 8 may perform various operations described herein, including storing zip code location information to some ID, depending on the type of service being utilized. This ID could be, for example, an IP address, a directory number (DN), a MAC address, a Port ID, an antenna face, a private user ID, a public user ID, a line ID, a cable modem ID, as well as MIN, IMSI, MEID or other “hardware” IDs, etc. Again, this list is not exhaustive and other types of IDs may be stored in the database server 8. This information may be stored in a table 10, as described more fully below. The server 8 may be specially constructed for the required purposes, perhaps as a modest increment to the data already stored by the core network for the particular access key, or it may comprise one or more general-purpose computers selectively activated or reconfigured by one or more computer programs stored in the computer(s). Such computer program(s) may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); and the like.

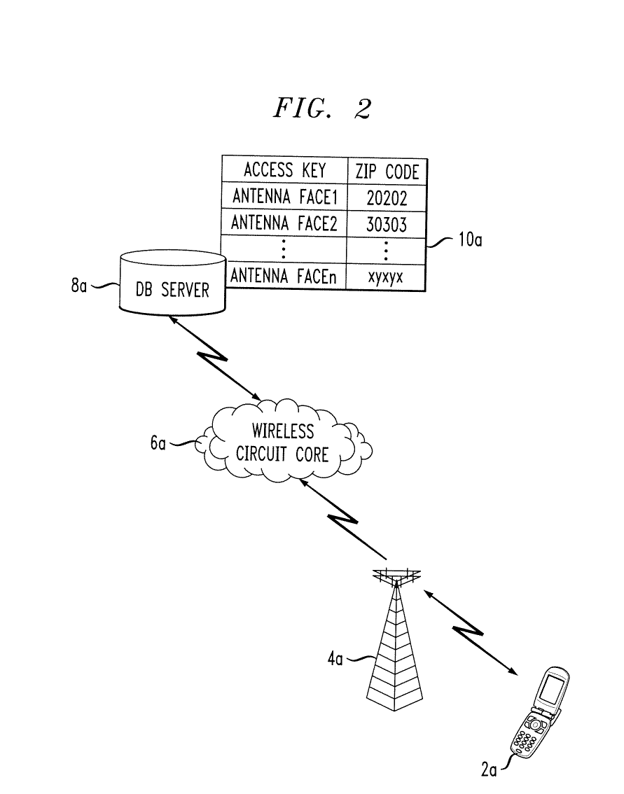

FIG. 2 provides a view of a wireless system into which the presently described embodiments may be incorporated. In this case, the communication device comprises a mobile station 2a. It is noted that the terms “mobile subscriber,” “network subscriber,” “mobile station,” and “mobile user” may be used interchangeably. The mobile station (MS) 2a may refer to a human individual who has subscribed to one or more mobile wireless services. The term “mobile station,” as used herein, may also include a mobile service user who uses the subscribed wireless service(s) with a mobile telephone handset or with a computer equipped for wireless communication or with any other similar device. Further, “mobile communication” may include voice, data or any other information communicated via a mobile wireless network. A “mobile station” includes a wireless terminal used by the subscriber to access network services over a radio interface. The wireless terminal may comprise a portable unit (e.g., hand-held unit), a unit installed in a vehicle, or a fixed location unit. The wireless terminal is the interface equipment used to terminate the radio path at the subscriber. Although the present system and method may be used with any type of network (wired and wireless, for example), the subscriber is typically a mobile subscriber using a mobile station.

The access server 4a generally comprises a base station, which is operatively connected to a wireless circuit core 6a, which may encompass any known wireless technology, including TDMA, CDMA, UMTS, GSM, etc. The base station 4a provides the means for the mobile station 2a to access network services using radio. Although not shown, the base station 4a typically includes a base station controller and a base transceiver system. In this regard, the cell phone users may be connected through a base station system for placing calls. The base station system consists of base station controllers and base transceiver stations, and its primary responsibility is to transmit voice and data traffic between the mobile stations.

The wireless circuit 6a may interconnect with an SS7 (Signaling System No. 7) network as a backbone network to transport TIA-41 signaling messages through the telecommunications system. SS7 packets may be used to convey signaling information from an originating point to a destination point through multiple switching nodes in the mobile network, which may encompass more than one wireless network operated by one or more service providers. SS7-based transactions may query databases and invoke functions at remote points throughout the mobile wireless network to establish and maintain calls and to perform reliable call management functions. The SS7 backbone network may be owned and operated by the same service provider as the one operating the interconnected wireless network. Alternatively, a wireless service provider may join an independent SS7 network provider to accomplish desired call routing. Service control points (not shown) are special types of end signaling points in an SS7 network that perform transaction processing of remote operations.

The database server 8a would thus store data relating to the zip code locations of one or more antenna faces, as shown in the table 10a in FIG. 2.

In one embodiment, the base station antenna broadcasts a message such as “ZIPCODE.” The base station 4a accesses the database server 8a. The server 8a could be in the base station, the base station controller, or a mobile switching center. In another embodiment, the mobile station 2a queries the base station 4a for “ZIPCODE.” The base station 4a accesses the database server 8a as in the previous example.

Generally, the mobile user 2a may dial a pre-defined directory number (e.g., 1-800-ZIPCODE) or a feature activation code (*777). The core network 6a will then query the database server 8a, obtain the zip code, and then “return” it to the user 2a. “Returns” could be the core network 6a playing an announcement.

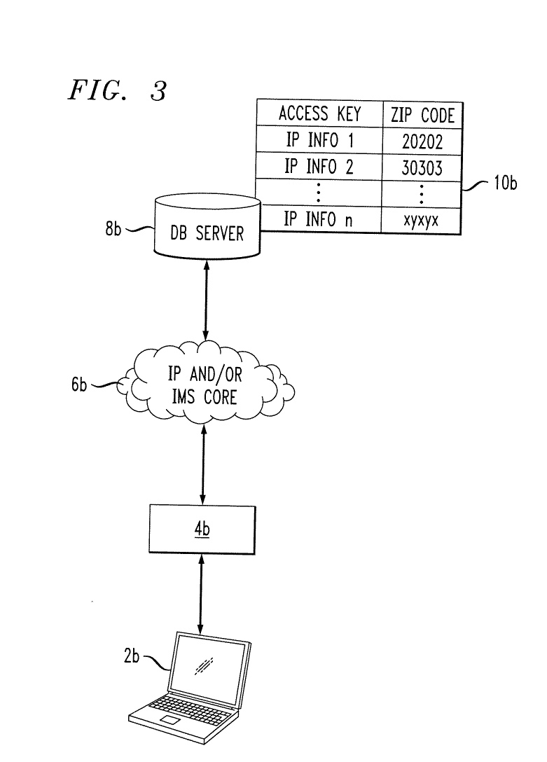

FIG. 3 provides a view of an IP or IMS system into which the presently described embodiments may be incorporated. In this case, the communication device 2b may comprise a PC, a PDA, an analog phone, an IP (e.g. SIP) device, a mobile handset, a dual mode handset, etc., with the appropriate access server for each.

The access server 4b may comprise a cable modem, an IMS access gateway, an ISP server, or a similar device, and it is operatively connected to an IP and/or IMS core 6b.

The database server 8b would thus store data relating to the zip code locations of one or more IP addresses, as shown in the table 10b in FIG. 3. It is to be understood that an IP address is but one type of ID. It could be the ID of a cable modem, a MAC address, or a port of a DSL, etc.

In this embodiment, the IP access connection point connects to the database server 8b for the “ZIPCODE.” The database server 8b could be a DHCP (Dynamic Host Configuration Protocol) with zip code extensions or it could be an ISP server database. Using existing network access methods, the database server 8b will be queried and the zip code will be returned to the PC. Some exemplary methods include (a) the DHCP method and (b) the website method. With the DHCP method, when the user plugs in or goes on the air with a wireless card, a DHCP query is performed, which also returns the zip code. The PC could display the zip code as shown above or it could make it available to the Auto-Zip-Fill enabled browser. As for the website method, the same procedure requesting Internet service may be used, i.e., in redirecting to the ISP's web page the user could be informed of the current zip code.

Alternatively, using, for example, a soft phone client on the PC, the IP user 2b may dial a pre-defined directory number (e.g., 1-800-ZIPCODE) or a feature activation code (*777). The core network 6b will then query the database server 8a, obtain the zip code, and then “return” it to the user 2b. “Returns” could be the core network 6a playing an announcement.

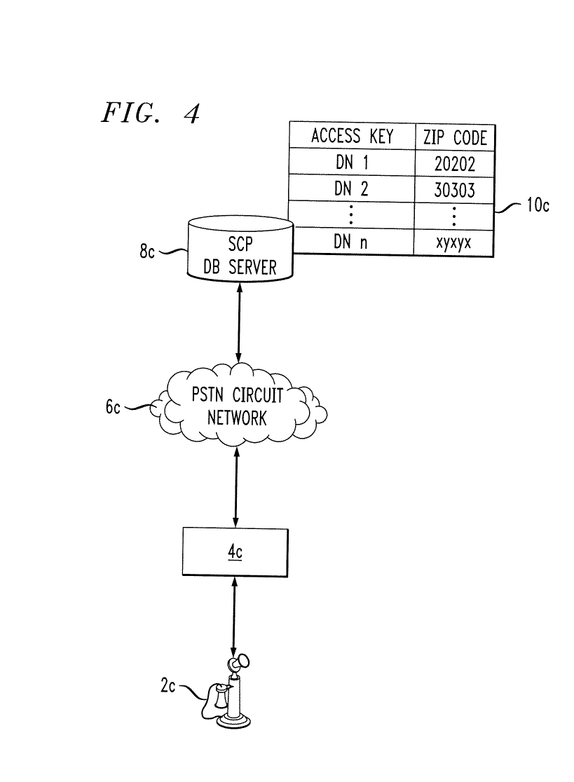

FIG. 4 provides a view of PSTN system into which the presently described embodiments may be incorporated. In this case, the communication device 2c comprises a wireline phone. The access server 4c may comprise, for example, a network switch operatively connected to the PSTN circuit network 6c. It is important to note, however, that this could also be a mobile device (where the cell site does not broadcast as in FIG. 2)—and the mobile device dials the 800 number. Or the user could be on a PC or PDA and the access point/DHCP is not sophisticated enough to give the appropriate zip code—so the user could use skype or other soft phone to call the 800 number.

The database server 8c may comprise, for example, an SCP (service control point), and would thus store data relating to the zip code locations of one or more directory numbers, as shown in the table 10c in FIG. 4. Again, it is to be understood that this could be a DN, an IP address, a hardware line equipment ID or any other type of ID.

In this embodiment, the PSTN/POTS user may dial a pre-defined directory number (e.g., 1-800-ZIPCODE) or a feature activation code (*777). The core network 6c will then query the database server 8c, obtain the zip code, and then “return” it to the PSTN user 2c. “Returns” could be the core network 6c playing an announcement.

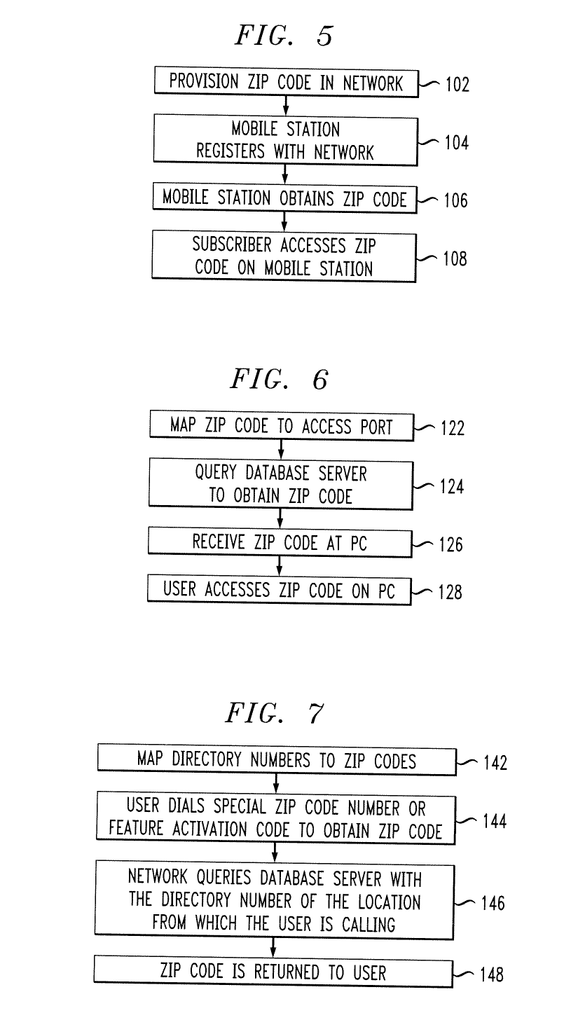

With reference now to FIG. 5 (and to FIG. 2), a method of determining the zip code in which a cellular/wireless/Wi-Fi device is located is shown. Initially, wireless access points, cell sites, cell site antennas or cell sectors are provisioned with the appropriate zip code. A centralized database is then populated with the zip code for each particular cellular/wireless/WiFi access point (102). The centralized database can be a mobile switching center (MSC) or a central server, so that the cell would not necessarily know its zip code unless it asks or is told it by the MSC. The data could be stored at the cell site, in the MSC, or in a centralized server, such as the zip code location database server 8a, and the cell site will have access to the data wherever it is stored.

Even though a cell site or sector may cover a larger geographic area than a single zip code, a single representative zip code of the area can be used. This facilitates information retrieval from location based web services that do not have data for all zip codes.

There are several ways that provisioning could happen: statically, where the service provider would update some data in the database, or the information could be entered on a form associated with the cell site that assigned the zip code to the cell sector/face. A wireless network could dynamically update the database as the user registers or moves from cell site/antenna/face, and a Wi-Fi network could dynamically update the database as the user registers or moves between wireless access points.

Next, the mobile station 2a registers with the network in the usual manner (104). The mobile station 2a then obtains the zip code in which it is located (106). This may be accomplished in one of several ways:
a) The base station broadcasts or narrowcasts its zip code on the forward control channel or other channel generally available to all mobiles. The mobile station 2a scans the forward control channel, acquires the zip code, and stores the zip code locally. By way of background, control channels carry data all of the time. The forward control channel, transmitted from a base station to the mobile phone, is continuous and carries a number of different kinds of messages, the format of which are spelled out in detail in the EIA specification. The reverse control channel is shared by a number of mobiles, each of whom transmits brief messages to the nearest base station. Narrowcasting is distributing the signal to a subset of user devices on a shared channel.
b) A new message is defined where the mobile phone 2a queries the network over a control channel and the network responds with the correct zip code.

Thus, the zip code is forwarded to the mobile station 2a. This may be accomplished by any number of means, such as by sending an SMS (short message service) message containing the zip code, announcing the zip code over a voice channel, displaying the zip code on the screen, or storing the zip code in the mobile station 2a. The subscriber may then access the zip code on the mobile station 2a by clicking on an icon, or stepping through some menu(s), for example, “Menu->Tools->Zip Code,” or through some built-in application such as a web browser (108). Alternatively, the zip code could simply be displayed perpetually on the default display on the mobile station 2a, for example, next to the power level icon, the VM icon, etc.

The user, having found out the zip code using the invention, can now use it to their advantage in a number of ways. For example, the user could find the nearest sushi restaurant by accessing Google with the zip provided by the phone in step 2, for example, with a short message (TO: Google TEXT: sushi 60566).

Likewise, a browser on the mobile station 2a could be used with traditional browser interface, i.e., bring up browser with Auto-Zip-Fill capability, go to www.google.com, and then input “sushi *zip” on the search line; the browser with Auto-Zip-Fill application would automatically translate the “*zip” to the zip code that was determined in step 106. The query that would be sent to Google would include the numeric zip code (not *zip). While the general Auto-Fill capability of web browsers is well known, this invention adds the ability to translate *zip (or other keystroke sequence) to the automatically derived current zip code.

Accordingly, this invention provides a coarse location rather than a precise location, and, in the wireless setting, advantageously (a) reduces costs because no special network equipment is needed, (b) incurs no significant delay to the mobile device in acquiring the provided location (zip code) because no satellite measurements are needed (which can take tens of seconds), (c) has a greater equivalent network capacity because there's no centralized network equipment providing the “location” information via lengthy calculations, and (d) provides a type of location information (zip) that's readily used as a “key” to a wide variety of information on the internet (as opposed to geo-location or latitude/longitude).

With reference now to FIG. 6 (and to FIG. 3), a method of obtaining a zip code via a PC 2b (e.g., hotel access) is shown. There is a database in the network such as a DHCP or a database application server linking the access port to the local zip code. This would to be similar to the cell site database, where the owner of the DHCP database or access point database would enter static zip code information into the database. Further, an IP network could dynamically update the database as the user registers or moves between IP ports.

Thus, the mapping of the zip code to the access port (e.g., it could be the IP address or jack number) is populated by the hotel's Internet service provider (122).

Next, using existing network access methods, the database server will be queried (124) and the zip code will be returned to the PC (126). Some exemplary methods include (a) the DHCP method and (b) the website method. With the DHCP method, when the user plugs in or goes on the air with a wireless card, a DHCP query is performed, which also returns the zip code. The PC could display the zip code as shown above or it could make it available to the Auto-Zip-Fill enabled browser. As for the website method, the same procedure requesting Internet service may be used, i.e., in redirecting to the ISP's web page the user could be informed of the current zip code. These procedures involve a mechanism whereby the service provider knows the user's location so that they can “brand” the web page with the hotel logo, as known in the art.

The user then accesses the zip code by clicking on an icon, or stepping through some menu(s), for example, “Menu->Tools->Zip Code,” or through some built-in application such as a web browser (128). Alternatively, the zip code could simply be displayed perpetually on the default display on the screen, for example, in the Notification area of the Microsoft Windows XP desktop.

The user, having found out the zip code using the invention, can now use it to their advantage in a number of ways as described above.

With reference now to FIG. 7 (and to FIG. 4), a method of providing the zip code for a standard wireline phone is shown. It is to be understood that this is just an example. This could be used by a mobile phone or softphone, where the intelligence/database is only in the network-based database—not in the DHCP/access point database.

There is a database in the network (e.g., the SCP), which contains a mapping of DNs to zip code. This is populated when a wireline subscriber sets up service (142) for that DN, so that the database contains an entry associating DN to its zip code.

The SCP database 8c could be provisioned statically with DNs and zip codes for “hard wired” phones. Furthermore, when a user “registers” in the network, the network could send data to the network database (e.g., an SCP). For example, the DHCP, when it assigns and IP address, could be further provisioned to send information to the SCP with the user's IP address and zip code. Or the cell site could send the IP address, DN, MIN or IMSI and zip code to the network database.

Next, a person is in a hotel and wants to find out a nearby sushi restaurant. So she calls 1-800-zip-code (1-800-947-2633) to find out the zip code of the hotel (144). The phone number of the hotel may or may not be shown on the phone.

The network then queries the zip code database with the hotel's phone number (146). The zip code is returned to the user, e.g., using an interactive voice response unit to tell the user what zip code they are in (148). Thus, even though the caller does not know her phone number, the network obtains it and uses it to derive the zip code.

It should also be noted that “zip code” is used herein to refer not only to U.S. zip codes but also “postal codes” in general around the world. The invention is not limited in application to the U.S. Some portions of the above description were presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems will be apparent from the description. In addition, the present invention is not described with reference to any particular programming language. It will be appreciated that a variety of programming languages may be used to implement the teachings of the invention as described herein.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. An apparatus for determining the zip code of a communication device in a network, the apparatus comprising:
a core network:
an access server operatively connected to the core network providing network access for one or more communication devices; and
a zip code location database server operatively connected to the core network, wherein the zip code location database server is adapted to store zip code location information for one or more IDs in the core network.

2. The apparatus of claim 1, wherein the communication device is adapted to receive a zip code relating to the location of the communication device from the network and make it available to other applications in the communication device.

3. The apparatus of claim 2, wherein the communication device is further adapted to receive an SMS message containing the zip code, an announcement including the zip code over a voice channel, display the zip code on the device's screen, or store the zip code.

4. A method of obtaining the zip code corresponding to the location of a user's communication device in a wireless-based network, the method comprising:
storing zip code data for a plurality of wireless access points, cell sites, cell site antennas and cell sectors in a server;
registering a communication device with the network;
receiving a zip code query from the communication device;
obtaining the zip code in which the communication device is located; and
forwarding the zip code to the communication device.

5. The method of claim 4, wherein the zip code data is stored at the cell site, in a mobile switching center (MSC), or in a zip code location database server.

6. The method of claim 4, wherein the forwarding step comprises sending an SMS message containing the zip code, announcing the zip code over a voice channel, displaying the zip code on the screen, or storing the zip code in the communication device.

7. The method of claim 4, wherein the zip code data is provisioned by associating a zip code with the cell site, the cell sector, the antenna face, or the wireless access point to define zip code data and populating the server with the zip code data.

8. The method of claim 4, further comprising:
the base station broadcasting or narrowcasting its zip code on the forward control channel or other channel available to a multiplicity of communication devices.

9. A method of obtaining the zip code corresponding to the location of a user's communication device in an IP-based network, the method comprising:
storing zip code data for a plurality of access points in a zip code location database server;
obtaining the zip code relating to the location of the communication device; and
forwarding the zip code to the communication device.

10. The method of claim 9, wherein the zip code data is stored in a DHCP, in an Internet service provider's server or in a zip code location database server.

11. The method of claim 9, further comprising:
querying the zip code location database server for the zip code in which the communication device is located.

12. The method of claim 9, further comprising:
automatically sending out the zip code in which the communication device is located whenever the user connects to the network to get an IP address.

13. The method of claim 9, further comprising:
via a Web browser on the communication device, automatically translating a keystroke sequence to the zip code that was obtained from the network.

14. A method of obtaining the zip code corresponding to the location of a user's communication device in the public switched telephone network (PSTN), the method comprising:
storing zip code data for a plurality of wireline subscribers in a zip code location database server;
receiving a zip code query from a wireline user having a communication device with an associated directory number or hardware line equipment ID;
querying the zip code database server with the associated directory number or hardware line equipment ID; and
forwarding the zip code in which the communication device is located to the user.

15. The method of claim 14, further comprising:
populating the zip code location database server by providing a mapping of directory numbers to zip codes, wherein the zip code location database server is populated when a wireline subscriber sets up service for that directory number, whereby the database contains an entry associating the directory number to its zip code.

16. The method of claim 14, wherein forwarding the zip code comprises announcing the zip code to the user over a voice channel.

17. The method of claim 14, further comprising:
populating the zip code location database server statically with directory numbers and zip codes for hard wired phones.

18. A method of providing the zip code for the location of a communication device, where the communication device calls a public phone number to access the zip code, the method comprising:
dynamically populating a zip code location database server to provide a mapping of ID to zip code;
receiving a zip code query from a user having a communication device with an associated ID;
querying the zip code database server with the associated ID; and
providing the zip code in which the communication device is located to the user.

19. The method of claim 18, wherein the zip code location database server is populated statically with directory numbers and zip codes for hard wired phones.

20. The method of claim 18, wherein the zip code location database server is populated dynamically with zip code information that is mapped to associated IDs.

21. The method of claim 18, wherein:
a wireless network dynamically updates the database as the user registers or moves from cell site/antenna/face;
a Wi-Fi network dynamically updates the database as the user registers or moves between wireless access points; and
an IP network dynamically updates the database as the user registers or moves between IP ports.
